(19) United States
(12) Patent Application Publication
(10) Pub. No.: US 2011/0228950 A1
(43) Pub. Date: Sep. 22, 2011

(54) HEADSET LOUDSPEAKER MICROPHONE

(75) Inventors: Magnus ABRAHAMSSON, Loddekopinge (SE); Markus Palmgren, Rydeback (SE)

(73) Assignee: Sony Ericsson Mobile Communications AB, Lund (SE)

(21) Appl. No.: 12/727,981

(22) Filed: Mar. 19, 2010

(51) Int. Cl. H04B 15/00; H04R 25/00

(52) U.S. Cl. 381/94.1; 381/370; 381/163

(57) ABSTRACT

A headset system which may be utilized for various forms of communication and multimedia. The headset system may include a number of earpieces which may be configured to change its operation state based on a position of the earpiece relative to a user's ear and a desired use. The earpiece may be further configured to provide noise cancellation based on its position and operational state.

### TECHNICAL FIELD

The invention generally relates to a portable communication device with switchable operation modes and adaptive noise cancellation.

### BACKGROUND

The field of mobile communications and electronic multimedia has seen significant increases in usage during the past few years. It is not uncommon for a single user to utilize several devices (e.g., mobile phones and audio/video players) at once.

### SUMMARY

While using multiple communication or multimedia devices, a user must constantly switch from one device to another. A single device capable for delivering multiple types of communication and multimedia data to a user is needed. Such a device should be able to adjust to different modes of operation. Thus, in order to reduce the number of devices a user may need to carry, a single communications unit is desired. The communications unit must be able to adapt to different modes of operation while providing good audio quality.

According to example embodiments, a portable communications unit for generating and receiving audio signals is presented. The portable communications unit may be configured to transmit or receive, for example, an audio multimedia data stream (e.g., an MP3 audio) or a mobile communication signal. The communications unit may include at least one earpiece and a location unit. The location unit may be configured to provide an estimation position of the earpiece. In one example embodiment, the location unit may be configured to set the estimation position to near or far if the earpiece is located in near or far proximity, respectively, with respect to a primary user's ear.

In example embodiments, the communication unit may further include an operational switching unit that may be configured to receive the estimation position and manage an operational state of the earpiece based on the estimation position and a communication notification. For example, the operational switching unit may be configured to change the operational state of the earpiece to a speaker function if the estimation position is near. The operational switching unit may also be configured to change the operational state of the earpiece to a microphone function if the estimation position is far and a communication notification is received.

According to example embodiments, the communication unit may also include a noise cancellation unit that may be configured to eliminate receiver ambient noise if the estimation position is near. The noise cancellation unit may also be configured to eliminate transmission ambient noise of outgoing communication data when the estimation position is far and the communication notification is received. The elimination of transmission ambient noise may be performed by subtracting a first observed signal from the earpiece with a second observed signal from at least one other earpiece, with the subtraction resulting in the outgoing communication data. In example embodiments, the at least one other earpiece may have a near estimation position.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is close-view depiction of a headset earpiece according to example embodiments;

FIG. 2 is a block diagram depicting the relationship between various components which may be included in the earpiece of FIG. 1; and

FIG. 3 is a flow diagram of example operational steps utilized by a noise cancellation unit of FIG. 2.

### DETAILED DESCRIPTION

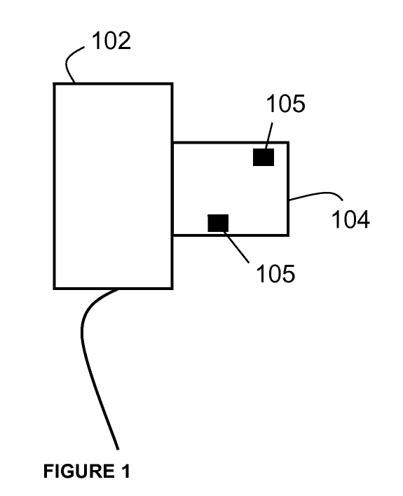

FIG. 1 illustrates an earpiece 102 of a headset, according to example embodiments. The earpiece may include an inner portion 104 which may be configured to fit in a user's ear. The earpiece may also include a number of sensors 105 that may be used to measure the proximity of the earpiece in relation to a user's ear. In an example embodiment, the sensor may be a capacitive touch sensor configured to detect when the earpiece has made skin contact on any number of predetermined positions on the earpiece. Another example embodiment may include a sensor if the form of an accelerometer. The accelerometer may be used to measure movement of the earpiece as it is moved from a user's ear to a location in front of a user's mouth. It should be appreciated that other type of sensors known in the art may be employed. For example, sensors used for measuring changes in pressure, light, movement, or acoustics may be employed. It should further be appreciated that any number of sensors may be employed and the sensors may be placed in any location (internally or externally) on the earpiece. Furthermore, it should be appreciated that the sensors employed in the earpiece need not be of a same type. It should also be appreciated that the type of earpiece employed need not be an internal earpiece. An earpiece configured to attach to, or rest on, an outer portion of a user's ear may also be utilized.

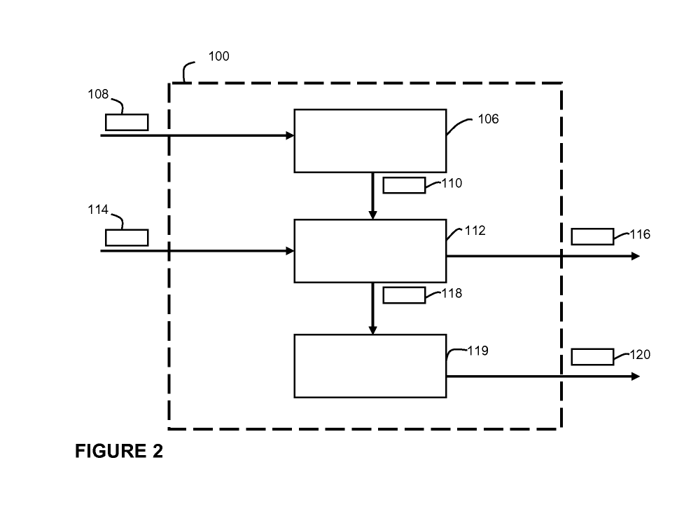

FIG. 2 is a block diagram depicting various components which may be included in a portable communication unit 100. The portable communication unit 100 may include a location unit 106 configured to receive measured data 108 obtained from the sensor. The location data may set a value of an estimation position based on the received measured data 108. The estimation position may be near if the measured data 108 indicates that the earpiece 102 is in close proximity to, or placed in, a user's ear. Similarly, the estimation position may be far if the measured data 108 indicates that the earpiece is in far proximity to, or not placed in, a user's ear.

Once determined, the estimation position 110 may be transferred to an operational switching unit 112. The operational switching unit may be configured to receive a notification 114 if a communication signal (e.g., a mobile communication signal) is present or if a communication is being initiated. The operational switching unit may be employed to change a current operation state of the earpiece. For example, the operational switching unit may set the operation state of the earpiece to a microphone function if two conditions have been met; (1) a notification 114 has been received by the switching unit 112, and (2) the estimation position of the earpiece is far. Similarly, if the earpiece is in a near position, the operational switching unit may set the operation state of the earpiece to a speaker function.

Once the operation of the earpiece has been set, the operational switching unit 112 may send instructions 116 to associated circuitry and/or software to implement the necessary changes. The associated circuitry and/or software may be located within the earpiece itself. Alternatively, the associated circuitry and/or software may be located anywhere within, or external to, the communications unit 100. The operational switching unit 112 may also send instructions 118 to a noise cancellation unit 119. The noise cancellation unit 119 may be used to eliminate ambient noise based on the instructions 118 which may indicate the current operation state, estimation position, and/or notification of a communication signal, or a communication initiation, associated with the earpiece. The noise cancellation unit 119 may also send noise cancellation instructions 120 to associated circuitry and/or software to implement the necessary changes.

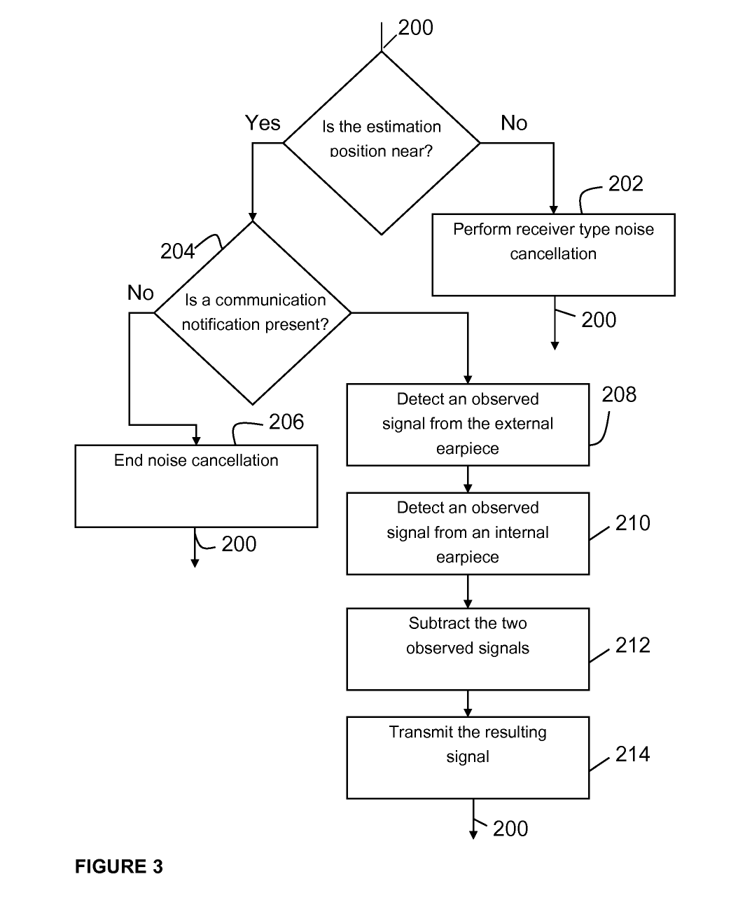

FIG. 3 is a flow diagram depicting example operational steps which may be taken by the noise cancellation unit 119. The noise cancellation unit 119 may first determine if the estimation position of the earpiece is near (200). If the earpiece is not in a near position, receiver type noise cancellation will be performed (202). Receiver type noise cancellation may take place regardless of the type of media being transmitted from the earpiece. In fact, the receiver type noise cancellation may take place even if no media is being transmitted from the earpiece, which would result in the earpiece functioning in a manner similar to that of a noise cancellation headset. The noise cancellation unit may thereafter continue to monitor the position of the earpiece (200).

If the of the earpiece is in a far position, the noise cancellation unit 119 may inquire as to whether or not a communication is in process or being initiated (204). The communication determination may be based on the notification 114. If it is determined that a communication is not in process or being initiated, the unit 119 may end noise cancellation for the earpiece (206). Thereafter, the noise cancellation unit 119 may continue to monitor the position of the earpiece (200).

If a communication process, or initiation, is detected, the noise cancellation unit 119 may cancel transmission ambient noise. In cancelling the transmission ambient noise, the noise cancellation unit 119 may receive a detected communication signal observed from the far earpiece (208). The noise cancellation unit 119 may also receive a detected signal observed from a secondary earpiece, which may be a near earpiece employing a speaker function (210). It should be appreciated that the earpieces of the headset may include any number of microphone sensors dedicated to receiving the observed signals or surrounding noise. The two observed signals may be subtracted from one another (212) and the resulting signal may be transmitted as an outgoing communication signal (214). Thus, during communication, the far earpiece may be utilized as a microphone held close to a user's mouth for voice pick up, while the secondary earpiece may be concentrated on background noise. Using the secondary earpiece to eliminate ambient noise may approve the quality of the outgoing communication signal. The noise cancellation unit 119 may thereafter continue to monitor the position of the earpiece (200).

It should be appreciated that example embodiments of the earpiece may not include a noise cancellation unit. Having the ability to place an earpiece with a microphone function close to a user's mouth may greatly reduce the presence of background noise in a communication signal.

While this invention has been particularly shown and described with references to example embodiments thereof, it will be understood by those skilled in the art that various changes in form and details may be made therein without departing from the scope of the invention encompassed by the appended claims.

The above mentioned and described embodiments are only given as examples and should not be limiting to the present invention. Other solutions, uses, objectives, and functions within the scope of the invention as claimed in the below described patent claims should be apparent for the person skilled in the art.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

It should also be understood that processes disclosed herein may be implemented in hardware, firmware, or software. If implemented in software, the software may be stored on any form of computer readable medium, such as random access memory (RAM), read only memory (ROM), compact disk read only memory (CD-ROM), and so forth. In operation, a general purpose or application specific processor loads and executes the software in a manner well understood in the art.

1. A portable communication unit for generating and receiving audio signals, the communication unit comprising:
at least one earpiece;
a location unit configured to provide an estimation position of the earpiece; and
an operational switching unit configured to receive the estimation position and manage an operational state of the earpiece based on the estimation position and a communication notification.

2. The communication unit of claim 1, wherein the location unit is further configured to set the estimation position to near or far if the earpiece is located in a near or far proximity, respectively, with respect to a primary user's ear.

3. The communication unit of claim 2, wherein the operational switching unit is further configured to change the operational state of the earpiece to a speaker function if the estimation position is near.

4. The communication unit of claim 2, wherein the operational switching unit is further configured to change the operational state of the earpiece to a microphone function if the estimation position is far and a communication notification is received.

5. The communication unit of claim 2, further comprising:
a noise cancellation unit configured to eliminate receiver ambient noise if the estimation position is near.

6. The communication unit of claim 2, further comprising:
a noise cancellation unit configured to eliminate transmission ambient noise of outgoing communication data when the estimation position is far and the communication notification is received.

7. The communication unit of claim 6, wherein the noise cancellation unit is further configured to subtract a first observed signal from the earpiece with a second observed signal from at least one other earpiece, the subtraction resulting in the outgoing communication data.

8. The communication unit of claim 7, wherein the at least one other earpiece has a near estimation position.

9. A method of portable communication comprising:
providing an estimation of a position of a headset earpiece; and
switching an operational function of the headset earpiece based on the estimation and a communication notification.

10. The method of claim 9, wherein the providing an estimation of a position further comprises:
sensing a proximity of the headset earpiece relative to a primary user's ear;
determining a location of the headset earpiece based on the sensing;
setting the estimation of the position to near if the earpiece is located in close proximity to the primary user's ear; and
setting the estimation of the position to far if the earpiece is located in far proximity to the primary user's ear.

11. The method of claim 10, wherein switching the operational function further comprises:
transitioning the operational function of the headset earpiece to a microphone function if the estimation of the position is far and the communication notification is received; and
transitioning the operational function of the headset earpiece to a speaker function if the estimation of the position is near.

12. The method of claim 10, further comprising cancelling receiver ambient noise when the estimation of the position is near.

13. The method of claim 11, further comprising cancelling transmitter ambient noise when the estimation of the position is far and the operational function is a microphone function.

14. The method of claim 13, further comprising subtracting a first communication signal observed by the earpiece with a second communication signal observed by at least one other earpiece.

15. The method of claim 14, wherein the estimation of the position of the at least one other earpiece is near.
